(19) United States
(12) Patent Application Publication
(10) Pub. No.: US 2008/0185426 A1
(43) Pub. Date: Aug. 7, 2008

(54) Method and Hardware Topology Presentation for Graphically Visualizing a Hardware Topology for a Drive System

(76) Inventor: Markus Fister, Erlangen (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 11/912,216

(22) PCT Filed: Apr. 19, 2006
(86) PCT No.: PCT/EP2006/061656

§ 371 Date: Oct. 22, 2007

(30) Foreign Application Priority Data
Apr. 22, 2005 (DE) 10 205 018 813.3

(51) Int. Cl. G06F 7/00

(52) U.S. Cl. 235/376

(57) ABSTRACT

The invention relates to methods and a hardware topology display for graphically visualizing a hardware topology of a drive system (10, 11, 12) of a machine tool, production machine, and/or robot. According to the invention, component symbols (3, 8, 9) representing physical components of the drive system (10, 11, 12) are visualized from a data record describing the drive system (10, 11, 12), the component symbols (3, 8, 9) being interlinked according to the connections (13, 14) of the physical components (10, 11) by means of said data record. The invention creates a method and a hardware topology display for graphically visualizing a hardware topology of a drive system (10, 11, 12) of a machine tool, production machine, and/or robot.

The invention relates to a method for graphically visualizing a hardware topology for a drive system in a machine tool, production machine and/or robot.

The invention also relates to a hardware topology presentation for a drive system in a machine tool, production machine and/or robot.

Today, machine tools, production machines and/or robots usually have a drive system which comprises a multiplicity of components. Thus, a commercially available drive system in such a machine usually has a drive device containing closed-loop and/or open-loop control functionalities and also converters and motors. Customarily, the drive device actuates a converter for each machine axle in the machine, and the converter in turn actuates a motor associated with the machine axle in order to drive the machine axle. Since a machine usually has a plurality of machine axles, e.g. for moving a tool in the plurality of directions, a drive device has a plurality of converters together with the associated motors connected to it directly or indirectly.

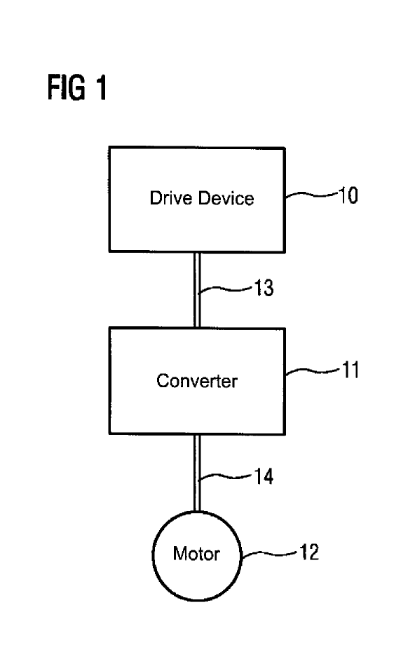

FIG. 1 shows a drive system of this kind in which a drive device 10 is connected to a converter 11 via a bus 13 (e.g. USB bus, Profibus or Ethernet bus) for the purpose of interchanging data. The converter 11 is connected to a motor 12 via a bus 14. The bus 13 is used to interchange control data, for example, between the drive device 10 and the converter 11, and the bus 14 can be used by the motor 12, for example, to notify the converter 11 and the drive device 10 of what type of motor is present and what motor data (e.g. power) it has, so that the drive device 10 can set parameters for closed-loop control of the motor as appropriate, for example.

In this case, FIG. 1 showed only one drive system in a machine with only one machine axle, a machine normally having a plurality of machine axles, as already stated, with a converter 11 and an associated motor 12 being connected to the drive device 10 directly or indirectly (via the converter) for each machine axle.

In addition to the components shown in FIG. 1, a drive system can naturally also have other components, such as sensors, which may likewise be coupled to the drive device 10 via a bus system.

Before a drive system of this kind can be started up, it needs to be configured as appropriate using a startup tool. That is to say that the drive system's software needs to be notified of what components the drive system comprises and how these components are connected to one another, i.e. what the appearance of the drive system's hardware topology is. When the drive system has been configured, the configuration of the drive system's hardware topology is used to produce an appropriate piece of drive software which runs in the drive device 10. In line with the stipulation, the hardware systems and the associated software are configured as appropriate.

For previous hardware topology presentations, the hardware topology of the drive system was stipulated using a list, for example. Two respective interconnected components were written to one row within the list, and appropriate statements in the columns of the list defined the interconnection of the two components, including the components' terminal assignments used. Another option is to use tree structures to map the hardware topology as appropriate.

However, these confusing forms of presentations lead to problems in understanding for many users, which means that configuration errors frequently arise. It is particularly difficult to make changes to the topology, e.g. in the form of a change to a connection from one component to another, since, by way of example, presenting the topology in the form of a list indicates the individual connections to the user only very confusingly and he is not provided with a graphical impression of the drive system on hand.

The invention is based on the object of providing a simple graphical visualization of a hardware topology for a drive system in a machine tool, production machine and/or robot.

This object is achieved by a method for graphically visualizing a hardware topology for a drive system in a machine tool, production machine and/or robot, where a data record describing the drive system is used to visualize component symbols representing physical components of the drive system, the data record being used to connect the component symbols to one another in line with the connections between the physical components.

This object is also achieved by a hardware topology presentation for a drive system in a machine tool, production machine and/or robot, where a data record describing the drive system can be used to visualize component symbols representing physical components of the drive system, the data record having been used to connect the component symbols to one another in line with the connections between the physical components. It is found to be advantageous that the component symbols have virtual terminals, with the data record being used to connect the virtual terminals of the component symbols to one another in line with the connections between the terminals of the physical components. This allows accurate presentation of the connection in line with the physical terminals of the drive system.

It is also found to be advantageous that the virtual terminals have the terminal labels of the terminals of the physical components. This allows the user to learn the terminal labels of the terminals of the physical components directly from the graphical visualization.

It is also found to be advantageous that the name and/or the type of the components and/or subcomponents integrated in the components are visualized. This allows the user to clearly visualize the name and/or the type of the component and/or of the subcomponents integrated in the components.

It is also found to be advantageous that the component symbols are connected to one another by means of lines. This allows particularly clear presentation of the connections.

It is also found to be advantageous that the connections between the component symbols and/or the component symbols can be altered by a user and/or new component symbols can be added and/or component symbols can be deleted by the user. This allows the user to easily manipulate the configured hardware topology of the drive system.

It is also found to be advantageous that the graphical representation of the component symbols essentially corresponds to the respective representative physical components. This allows simple identification of the component symbols.

It is also found to be advantageous that the component symbols can be moved. This allows the hardware topology of the drive system to be altered without confusion.

It is also found to be advantageous that the component symbols have a field showing a more detailed information item. This also allows other information to be visualized within the component symbol.

In this connection, it is found to be advantageous that the more detailed information item provided is an error information item which indicates an erroneous topology. This allows erroneous connections or inadmissible connections, for example, to be indicated in simple fashion.

It is also found to be advantageous that the component symbols have a further field, with selection of the further field by the operator prompting deactivation and/or identification of the associated physical component and/or input of user comments and/or calling of an electronic nameplate. This makes it easy to deactivate and/or identify the associated physical component and/or to input user comments and/or to call an electronic nameplate.

It is also found to be advantageous that the graphical visualization of the hardware topology of the drive system is compared with the physically present hardware topology of the drive system, and differences are visualized. This allows the user to establish differences between the existing physical hardware topology of the drive system and the hardware topology configured in the software.

It is also found to be advantageous that the component symbols have virtual terminals, with the data record having been used to connect the virtual terminals of the component symbols to one another in line with the connections between the terminals of the physical components.

Advantageous refinements of the hardware topology presentation can be found in similar fashion to advantageous forms of the method, and vice versa.

An exemplary embodiment is shown in the drawing and is explained in more detail below. In the drawing:

FIG. 1 shows a drive system based on the prior art, and

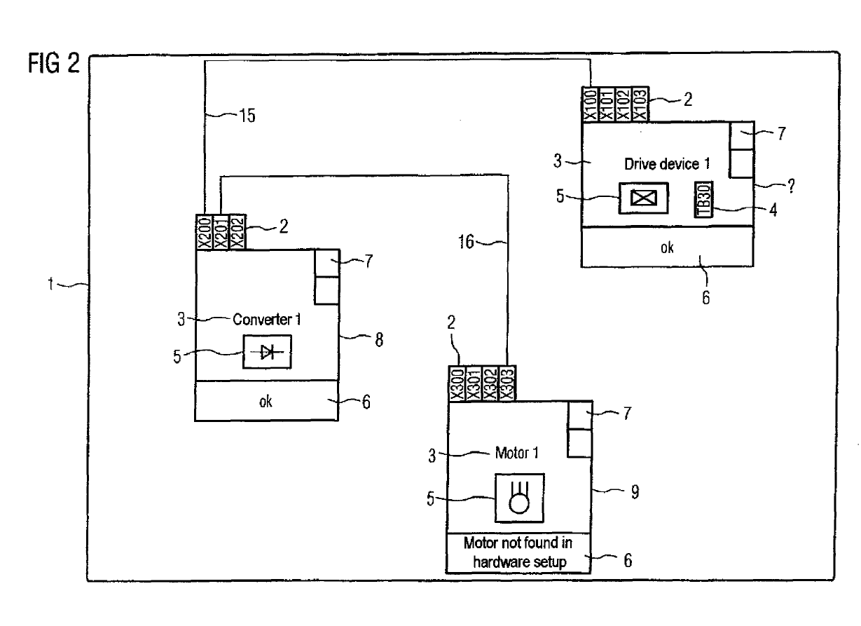

FIG. 2 shows an inventive hardware topology presentation for a drive system.

FIG. 2 shows an inventive hardware topology presentation for a drive system in a machine tool, production machine and/or robot, the graphical representation corresponding to the physical components shown in FIG. 1.

In this case, a data record describing the drive system from FIG. 1 is used to visualize component symbols 3, 8 and 9 representing physical components of the drive system on a screen 1. By way of example, the data record describes what physical components the drive system has and how these are connected to one another, e.g. by means of a bus system. A data record of this kind may, as already described, be in the form of a list, for example, which defines the connections between the terminals of the individual physical components of the drive system, inter alia. Referring to FIG. 2, a row in the list may be, by way of example, drive device 1 X100 converter 1 X200.

In addition, it goes without saying that a data record of this kind may also contain other information, such as what subcomponents (e.g. memory cards) the individual components of the drive system have and/or of what type the individual components are.

The component symbols 3, 8 and 9 have virtual terminals 2 which correspond to the physical terminals of the physical components, i.e. of the components which are really on hand. In this arrangement, the terminals have terminal labels which likewise correspond to the terminal labels of the physical components. The component symbols may be shown in the form of a pictogram or an icon, for example. Each component symbol has a name 3, which can be allocated by the user, and an icon for the physical component type which it represents.

In addition, a subcomponent which may be on hand (e.g. a memory card 4) is also visualized for the observer. The component symbols are connected to one another by means of lines 15 and 16 in line with their physical bus terminals. Thus, in the exemplary embodiment, the bus terminal X100 of the drive device 1 is connected to the bus terminal X200 of the converter 1, and the bus terminal X201 of the converter 1 is connected to the terminal X303 of the motor 1. The lines 15 and 16 correspond to the bus connections 13 and 14 shown in FIG. 1.

In addition, the component symbols have a field 6 which shows more detailed information. The more detailed information item displayed may be an erroneous topology, for example. In addition, the component symbols also have further fields 7, with selection of the fields by the operator being able to prompt deactivation and/or identification of the associated physical component and/or input of user comments and/or calling of an electronic nameplate, for example.

The inventive method involves the data record which describes the drive system being used to visualize component symbols 3, 8 and 9 which represent physical components of the drive system, the data record being used to connect the component symbols to one another in line with the connections between the physical components.

In this context, it is possible for a user to be able to alter the connections between the component symbols and/or the component symbols and or to be able to add new component symbols and/or for the user to be able to delete component symbols on the screen.

In addition, the component symbols can be moved on the screen 1 as desired. In one preferred embodiment, the graphical representation of the component symbols essentially corresponds to the respective representative physical components, e.g. in terms of their size or their appearance. Thus, by way of example, it is also conceivable for the component symbol 9 to represent one motor in the form of a motor, with the presentation also being able to be in three-dimensional form. The hardware topology's presentation produced afresh in this way can be stored in a data record.

When the drive system has been configured, the configuration of the drive system's hardware topology can be used to produce an appropriate piece of drive software which runs in the drive device 10. In this case, the drive software has parameters set for it as appropriate.

In this context, the screen 1 may be part of a configuration tool, for example, which may be in the form of a laptop or notebook, for example. The drive device 10 is normally able to request the drive system's hardware topology which is physically on hand. In this case, it possible to compare the graphical visualization of the drive system's hardware topology with the drive system's hardware topology which is actually really physically on hand and to visualize differences. To this end, the configuration tool is connected to the drive device. In the exemplary embodiment, for example, the field 6 is used to indicate that the motor 1 (component symbol 9) has not been found in the physical hardware setup. Since, on the other hand, the drive device 1 and the converter 1 have been found in the physical hardware setup, an “OK” is displayed in the text field 6 for the respective associated component symbol.

In addition, by way of example, it is also possible to select one of the other fields 7 of the component symbols 3, 8 and/or 9 in order to allow a kind of wiring test for the hardware components, in which selection of the appropriate further field on the associated physical component of the drive device prompts a lamp to light, for example, so that the user knows immediately where the converter 1 is located in an equipment cabinet, for example.

In this context, the inventive hardware topology presentation and the inventive method may be both an integral part of an external appliance, such as a startup tool (e.g. laptop), and an integral part of the drive device 10 or part of a superordinate controller connected to the drive device 10. The inventive method can be carried out both on the external appliance and on the drive device 10, and/or a superordinate controller.

1. A method for graphically visualizing a hardware topology of a drive system in a machine tool, production machine or robot, comprising the steps of:
providing a data record describing the drive system,
visualizing, by using the data record, component symbols representing physical components of the drive system, and
connecting the component symbols to one another commensurate in line with connections between the physical components.

2. The method as claimed in claim 1, wherein the component symbols have virtual terminals, with the data record being used to connect the virtual terminals of the component symbols to one another commensurate with the connections between the terminals of the physical components.

3. The method as claimed in claim 2, wherein the virtual terminals have terminal labels of the terminals of the physical components.

4. The method as claimed in claim 1, further comprising the step of visualizing a name or type, or both, of the physical components or of subcomponents integrated in the physical components.

5. The method as claimed in claim 1, wherein the component symbols are connected to one another by lines.

6. The method as claimed in claim 1, wherein the lines connecting the component symbols or the component symbols themselves can be altered, added or deleted by a user.

7. The method as claimed in claim 1, wherein a graphical representation of the component symbols essentially corresponds to the physical components represented by the component symbols.

8. The method as claimed in claim 1, wherein the visualized component symbols can be moved.

9. The method as claimed in claim 1, wherein the component symbols have a field showing additional information about a physical component.

10. The method as claimed in claim 9, wherein the additional information includes error information identifying an erroneous topology.

11. The method as claimed in claim 1, wherein the component symbols include a user-selectable field for performing operations selected from the group consisting of deactivation and identification of the physical component associated with the component symbol, input of user comments and polling an electronic nameplate.

12. The method as claimed in claim 1, further comprising the steps of comparing a graphical visualization of the hardware topology of the drive system with a physical component hardware topology of the drive system, and visualizing differences between the graphical visualization and the physical component hardware topology.

13.-22. (canceled)

23. An apparatus for hardware topology presentation of a drive system in a machine tool, production machine or robot, comprising:
a computer for storing a data record describing the drive system; and
a display for visualizing component symbols representing physical components of the drive system,
wherein the component symbols include virtual terminals which are connected with one another, based on the data record, commensurate with physical connections between physical terminals of the physical components, the component symbols further including a user-activatable field for deactivation or identification of the physical components associated with the component symbols.

24. The apparatus of claim 23, wherein the virtual terminals have terminal labels identifying the physical terminals of the physical components.

25. The apparatus of claim 23, wherein a name or a type of the physical components or of subcomponents integrated in the physical components are visualized.

26. The apparatus of claim 23, wherein the component symbols are connected to one another by lines.

27. The apparatus of claim 23, wherein a graphical representation of the component symbols corresponds substantially to a corresponding physical component.

28. The apparatus of claim 23, wherein the component symbols can be moved on the display.

29. The apparatus of claim 23, wherein the component symbols include an additional field with additional information about a physical component.

30. The apparatus of claim 29, wherein the additional information includes error information identifying an erroneous topology.
